(19) United States
(12) Patent Application Publication
(10) Pub. No.: US 2018/0065081 A1
(43) Pub. Date: Mar. 8, 2018

(54) SEPARATING APPARATUS FOR SEPARATING PARTICULATE CONSTRUCTION MATERIAL COMPONENTS FROM A GAS FLOW

(71) Applicant: CL Schutzrechtsverwaltungs GMBH, Lichtenfels (DE)

(72) Inventors: Frank HERZOG, Lichtenfels (DE); Florian BECHMANN, Lichtenfels (DE); Tim DÖHLER, Grossheirath (DE)

(73) Assignee: CL Schutzrechtsverwaltungs GMBH, Lichtenfels (DE)

(21) Appl. No.: 15/693,286

(22) Filed: Aug. 31, 2017

(30) Foreign Application Priority Data
Sep. 2, 2016 (DE) 102016116501.8

(51) Int. Cl. B01D 53/26; B01D 46/24; B01D 53/04; B33Y 30/00; B33Y 40/00; B29C 64/364; B28B 1/00; B22F 3/105

(52) U.S. Cl. CPC B01D 53/261; B01D 46/24; B01D 53/04; B33Y 30/00; B33Y 40/00; B22F 2003/1056; B28B 1/001; B22F 3/1055; B01D 2253/116; B01D 2257/80; B29C 64/364

(57) ABSTRACT

A separating apparatus provided for separating particulate construction material components from a gas flow containing particulate construction material components arising related to the process in a process chamber of an apparatus for additive manufacturing of three-dimensional objects by successive selective exposure and thus solidification of individual construction material layers of a construction material that can be solidified by means of an energy beam, comprising: —a housing structure defining a housing interior that is or can at least sectionally be run through by a respective gas flow, —at least one filter device arranged or formed in the housing interior (9) which comprises at least one filter element for separating the particulate construction material components from a respective gas flow, —at least one drying device which comprises at least one drying element for drying the gas flow.

### CROSS-REFERENCE TO RELATED APPLICATIONS

This application claims priority to German Patent Application serial no. 10 2016 116 501.8 filed Sep. 2, 2016, the contents of which is incorporated herein by reference in its entirety as if set forth verbatim.

The invention relates to a separating apparatus provided for separating particulate construction material components from a gas flow containing particulate construction material components arising related to the process in a process chamber of an apparatus for additive manufacturing of three-dimensional objects by successive selective exposure and thus solidification of individual construction material layers of a construction material that can be solidified by means of an energy beam.

Such separating apparatuses are actually known. Respective separating apparatuses serve to separate particulate construction material components from a gas flow containing particulate construction material components arising related to the process in a process chamber of an apparatus for additive manufacturing of three-dimensional objects. The gas flow typically comprises non-solidified construction material loosened from the construction plane related to the process.

Although to date the separation of respective particulate construction material components from respective gas flows has been resolved satisfactorily, there is sometimes the problem of moisture enrichment, which has negative effects on the respective additive construction process and the three-dimensional objects that are or can be manufactured additively with it.

Previous approaches to reduce the moisture content provide for targeted temperature control of respective separating apparatuses prior to their use in an additive manufacturing process. These approaches are, for example, because they cannot be implemented in situ, inefficient and involve great effort regarding systems engineering, as separate temperature control devices or ovens for the tempering of respective separating apparatuses are to be provided.

Known separating apparatuses are therefore limited as regards their scope of functions to the separation of respective particulate construction material components and do not feature any further functionalities beyond that, e.g., with regard to a reduction of the moisture content or a preparatory inertization prior to initial operation within the scope of an additive construction process.

The invention is therefore based on the object to provide, in contrast to the above, especially in terms of an expanded scope of functions, an improved separating apparatus.

The object is solved especially by a separating apparatus according to claim 1. The dependent claims relate to possible embodiments of the separating apparatus. The object is furthermore solved by an arrangement according to claim 8. The dependent claims relate to possible embodiments of the arrangement.

The separating apparatus described herein is generally provided for separating particulate construction material components from a, typically inert, gas flow containing particulate construction material components arising related to the process in a process chamber of an apparatus for additive manufacturing of three-dimensional objects by successive selective exposure and thus solidification of individual construction material layers of a construction material that can be solidified by means of an energy beam. As shown in the following, the separation of the particulate construction material components from the gas flow can also be referred to or considered as filtering of the particulate construction material components from the gas flow, filtering of the gas flow in short; the separating apparatus can insofar also be referred to or considered as filter apparatus.

A fundamental functional purpose (functionality) of the separating apparatus is hence the separation of particulate construction material components from respective gas flows containing particulate construction material components. The construction material components to be separated are typically construction material particles not solidified within the scope of additive construction processes, i.e., especially what is called “weld or sinter spatters”, loosening from the construction plane related to the process.

The separating apparatus comprises a housing structure (“housing”) defining a housing interior that is or can at least sectionally be run through by a respective gas flow. The housing can be designed closed to the outside such that the housing interior is or can be sealed off from the outside to exclude any interaction between the atmosphere within the housing and the, regularly not inert, ambient atmosphere of the housing. Of course, the housing can be provided with suitable access facilities, i.e., for example, flap elements, which allow a user to access the housing interior if necessary.

In the housing interior, at least one filter device is arranged or formed. The filter device comprises at least one filter element for separating the particulate construction material components from a respective gas flow. The filter element preferably has a drum-like geometric structural design (“drum filter”), as this features a high specific filter (surface) area and thus a high filter efficiency. The concrete physico-chemical design of the filter element is to be defined with regard to the concrete construction material particles to be separated from the gas flow, i.e., especially their physico-chemical properties.

Apart from the separation of particulate construction material components contained in respective gas flows, another functional purpose (functionality) of the separating apparatus is drying respective gas flows. Drying a gas flow is understood to mean especially the reduction of any moisture content of the gas flow. The reduction of the moisture content typically also involves a reduction of the fraction of any possibly existing reactive gases, i.e., especially oxygen.

For this purpose, the separating apparatus comprises at least one drying device. The drying device comprises at least one drying element for drying a respective gas flow. The drying element can be a (loose) powder of a suitable drying material, as this has a high specific drying (surface) area and thus a high drying efficiency. The drying device or drying element is typically connected downstream of the filter element, i.e., arranged or formed downstream of the filter element as regards the gas flow. The drying device may comprise several, possibly different, drying elements which, as replacement elements, are or can be connected removably (in a damage-free and non-destructive manner) with the drying device. Generally, the drying device can be arranged or formed inside or outside the housing interior defined by the housing.

In the first variant, the or a drying device can especially be arranged or formed on an insert component which can be connected removably (in a damage-free and non-destructive manner) with the housing, especially formed or arranged downstream of the filter device. The insert component can subdivide the housing interior into an upper housing interior area located above the insert component and a lower housing interior area located below the insert component. The insert component can have at least one flow opening that can be run through by the gas flow. The drying element can be arranged or formed in the area of the flow opening, i.e., especially above and/or below the flow opening. The first variant allows an extremely compact integration of the drying device into the separating apparatus.

In the second variant, the or a drying device can be arranged or formed on or in an, especially tubular, pipe element that is or can be coupled with the housing upstream or downstream as regards the gas flow. The drying element can be arranged or formed on or in an, especially tubular, pipe element section that can be run through by the gas flow.

The drying element can, for example, be formed as or at least comprise an adsorptive drying element provided for adsorbing moisture. The adsorptive drying element allows an adsorption of moisture contained in the gas flow. The drying element can be, for example, a molecular sieve, which allows an adsorptive connection or bonding of water molecules. As actual drying material, the drying element can comprise, for example, aluminosilicate (zeolite). The drying material can be (loose) powder. The pore size of a respective drying material is chosen purposefully with regard to the size of water molecules and can lie, for example, in a range between 0.3 and 1 nm. However, an adsorptive drying element can generally be of any material or material structure suitable for adsorptive bonding of water molecules due to its physico-chemical properties. Apart from the mentioned zeolites, for example, activated alumina or silica gel are possible as well.

In all cases, the gas flow runs purposefully with a comparably low flow rate, i.e., especially a flow rate of less than 3 m/s. Low flow rates improve, especially due to a longer residence or interaction time, both the separation result achievable with the filter device and the drying result achievable with the drying device.

The invention furthermore relates to an arrangement for an at least sectional inertization of a housing interior defined by a housing structure of a separating apparatus to be rendered inert, serving to separate particulate construction material components from an inert, i.e., serving for inertization, gas flow containing particulate construction material components arising related to the process in a process chamber of an apparatus for additive manufacturing of three-dimensional objects by successive selective exposure and thus solidification of individual construction material layers of a construction material that can be solidified by means of an energy beam. The arrangement comprises at least one first separating apparatus having a housing interior defined by a housing structure to be rendered inert and at least one second separating apparatus connected downstream of the at least one first separating apparatus comprising at least one drying device which comprises at least one drying element for drying the gas flow. The at least one first separating apparatus and the at least one second separating apparatus are connected with each other by means of a pipe structure that is or can be run through by an inert gas flow. The second separating apparatus can optionally comprise a filter device. The second separating apparatus can therefore especially be a separating apparatus as described. A separating apparatus as described can hence be used within the scope of the arrangement described in more detail in the following. Insofar, the embodiments in connection with the separating apparatus described above apply analogously to the arrangement.

The downstream connection of a respective second separating apparatus according to the arrangement allows a preparatory inertization (“preinertization”) of a first separating apparatus prior to initial operation within the scope of an additive construction process. The preinertization can be performed at least partially, i.e., the housing interior still contains a certain fraction of non-inert gas, i.e., for example, oxygen etc., or completely, i.e., the housing interior contains no fraction of non-inert gas. In both cases, a (considerable) reduction of the setup times for a first separating apparatus to be used within the scope of an additive construction process is possible. Of course, apart from the inertization, drying is performed as well, i.e., a reduction of any moisture content possibly contained in the respective first separating apparatuses.

The arrangement can comprise several first separating apparatuses to be rendered inert. The first separating apparatuses to be rendered inert are typically connected in series and form a group of separating apparatuses to be rendered inert. The at least one second separating apparatus is typically connected downstream (as regards the gas flow) of the group. Hence, the inert gas flow runs through the group first and then through the separating apparatus. A flow generation device providing for the generation of a respectively running gas flow, i.e., for example, a blower device, is thus typically connected upstream (as regards the gas flow) of the group. From the described arrangement it follows that the first separating apparatus of the group arranged closest to the second separating apparatus is typically the one that is rendered (pre)inert most rapidly.

The pipe structure can form a closed flow circuit, wherein the at least one first separating apparatus, possibly a respective group of first separating apparatuses, and the at least one second separating apparatus are connected into the closed flow circuit. The inert gas flow therefore runs circuit-like through the separating apparatuses, which allows a particularly efficient inertization of the first separating apparatuses.

The arrangement can comprise at least one detection device which is or can be coupled with the pipe structure for detecting information on the degree of moisture describing the moisture content or degree of moisture of the gas flow running through the pipe structure and/or a detection device for detecting information on the degree of inertization describing the degree of inertization of the gas flow running through the pipe structure. Of course, separate detection devices can be provided for detecting respective information on the degree of moisture and respective information on the degree of inertization. The information on the degree of moisture, for example, can be determined or described by detecting the fraction of water molecules in the gas flow. The information on the degree of moisture gives an indication of the efficiency of the drying device or drying element, which can therefore be replaced (early) if required. The information on the degree of inertization can, for example, be detected or described by detecting the fraction of reactive gases, especially oxygen, or the fraction of inert gases, especially argon or nitrogen, in the gas flow. In any case, the detection device is equipped with suitable detection elements, i.e., especially sensor elements, for detecting the fraction of water molecules or the fraction of reactive gases in the gas flow.

The arrangement can furthermore comprise a control device implemented by hardware and/or software for controlling the fraction of inert gases in the gas flow and an inert gas supply device connected with an inert gas reservoir or inert gas source for supplying (additional) inert gas into the pipe structure. The control device is typically provided for controlling the operation of the inert gas supply device, especially dependent on information on the degree of inertization. The supply of (additional) inert gas into the pipe structure is performed especially when the fraction of reactive gases exceeds a certain threshold. The pressure increase involved with the supply of (additional) inert gas into the pipe structure is compensated via an opening valve device, for example, in the form of a pressure relief valve. With pressure compensation realized in such a way, gas, which, of course, also contains reactive gas components, escapes from the pipe structure, resulting in a successive reduction of the fraction of reactive gases.

Apart from the separating apparatus and the arrangement, the invention also relates to an apparatus (“apparatus”) for additive manufacturing of three-dimensional objects, i.e., for example, technical components or technical component groups, by successive selective exposure and thus solidification of individual construction material layers of a construction material that can be solidified by means of an energy beam. The energy beam can especially be a laser beam. The apparatus can be an SLM apparatus, i.e., an apparatus for performing selective laser melting methods (SLM methods), or an SLS apparatus, i.e., an apparatus for performing selective laser sintering methods (SLS methods). The selective solidification of respective construction material layers to be solidified is performed based on object-related construction data. Respective construction data generally describe the geometric or geometric structural design of the respective three-dimensional object to be additively manufactured. Respective construction data can be, for example, “sliced” CAD data of the object to be manufactured.

The apparatus comprises the functional components typically required for performing additive construction processes, i.e., especially an energy beam generation device for the generation of an energy beam, especially a laser beam, for successive, selective layer-by-layer solidification of individual construction material layers of a construction material, i.e., especially a particulate or powdered metal, plastic, and/or ceramic material, and a coating device for forming construction material layers to be solidified in a construction plane. A construction plane can be a surface of a carrying element, typically supported movably (in vertical direction), of a carrying device or a construction material layer. Generally, at least one construction material layer selectively solidified or to be selectively solidified is formed in a construction plane.

The apparatus furthermore comprises at least one separating apparatus as described above. The separating apparatus allows in situ both separation of respective particulate construction material components from a respective gas flow and drying of the gas flow. Drying reduces or prevents moisture enrichment, which has negative effects on the respective additive construction process and the three-dimensional objects that are or can be manufactured additively with it. All embodiments in connection with the separating apparatus apply analogously to the apparatus.

In the following, the invention will be explained again by describing the exemplary embodiments shown in the drawings. In which:

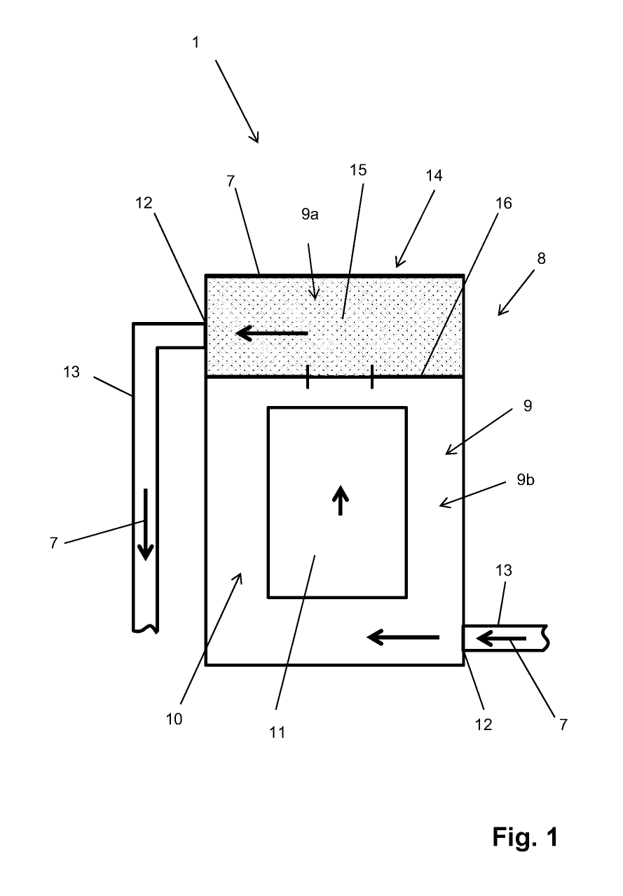

FIG. 1 shows a schematic diagram of a separating apparatus according to an exemplary embodiment;

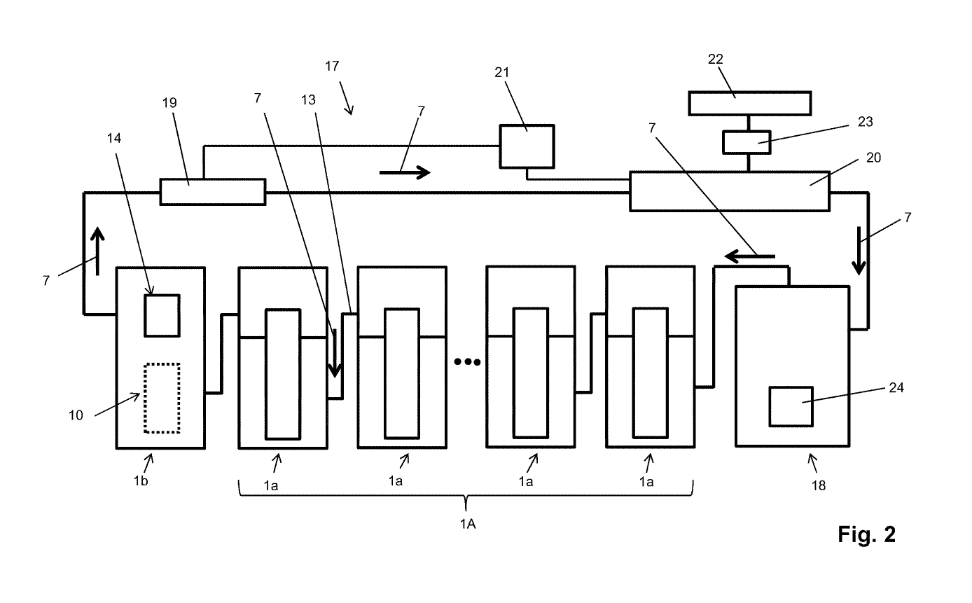

FIG. 2 shows a schematic diagram of an arrangement according to an exemplary embodiment; and

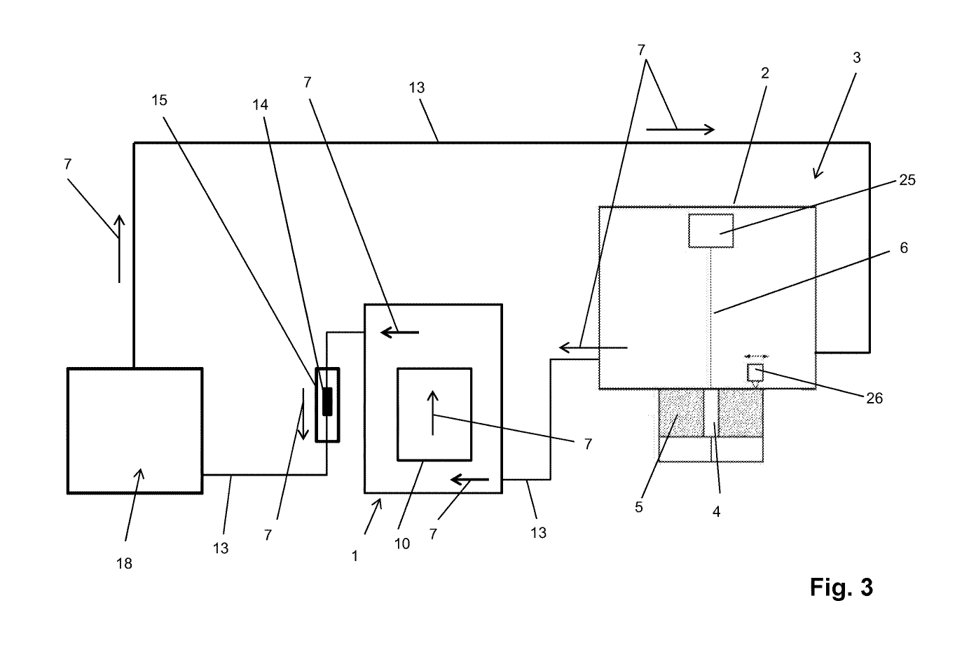

FIG. 3 shows a schematic diagram of an apparatus according to an exemplary embodiment.

FIG. 1 shows a schematic diagram of a separating apparatus 1 according to an exemplary embodiment.

The separating apparatus 1 is provided for separating particulate construction material components from a, typically inert, gas flow 7 containing particulate construction material components arising related to the process in a process chamber 2 of an apparatus 3 (cf. FIG. 3) for additive manufacturing of three-dimensional objects 4 by successive selective exposure and thus solidification of individual construction material layers of a construction material 5 that can be solidified by means of an energy beam 6. Another exemplary embodiment of a separating apparatus 1 is shown in connection with a respective apparatus 3 in FIG. 3, which shows a schematic diagram of an apparatus 3 according to an exemplary embodiment.

A first functional purpose (functionality) of the separating apparatus 1 is the separation of particulate construction material components from respective gas flows 7 containing particulate construction material components. The construction material components to be separated are typically construction material particles not solidified within the scope of additive construction processes, i.e., especially what is called “weld or sinter spatters”, loosening from the construction plane related to the process.

The separating apparatus 1 comprises a housing structure 8 (“housing”). The housing 8 defines a housing interior 9 that is or can be run through by a respective gas flow 7. Obviously, the housing 8 is provided with connection options 12, especially flange sections, for connecting respective, especially tubular, pipe elements 13 allowing the supply or discharge of a respective gas flow 7. From the arrangement of the connection options 12 according to FIG. 1 it results that the gas flow 7 runs from the bottom up through the housing interior 9 in the exemplary embodiment.

The housing 8 can be designed closed to the outside such that the housing interior 9 is or can be sealed off from the outside to exclude any interaction between the atmosphere within the housing 8 and the, regularly not inert, ambient atmosphere of the housing 8. The housing 8 can be provided with suitable access facilities (not shown), i.e., for example, flap elements, which allow a user to access the housing interior 9 if necessary.

In the housing interior 9, a filter device 10 is arranged. The filter device 10 comprises a filter element 11 for separating the particulate construction material components from a respective gas flow 7 running through the housing interior 9. The filter element 11 can have a drum-like geometric structural design (“drum filter”), which features a high specific filter (surface) area and thus a high filter efficiency. The concrete physico-chemical design of the filter element 11 is to be defined with regard to the concrete construction material particles to be separated from the gas flow 7, i.e., especially their physico-chemical properties.

The separating apparatus 1 furthermore comprises a drying device 14. The drying device 14 comprises a drying element 15 for drying a respective gas flow 7. In the shown exemplary embodiment, the drying element 15 is a (loose) powder of a suitable drying material, which has a high specific drying (surface) area and thus a high drying efficiency. The drying device 14 or drying element 15 is connected downstream of the filter element 11, i.e., arranged downstream of the filter element 11 as regards the gas flow.

Apart from the separation of particulate construction material components contained in respective gas flows 7, a second functional purpose (functionality) of the separating apparatus 1 is therefore drying respective gas flows 7. Drying a gas flow 7 is understood to mean especially the reduction of any moisture content of the gas flow 7. The reduction of the moisture content typically also involves a reduction of the fraction of any possibly existing reactive gases, i.e., especially oxygen.

The drying device 14 can generally be arranged or formed inside or outside the housing interior 9. In the exemplary embodiment according to FIG. 1, the drying device 14 is arranged inside the housing interior 9. The drying device 14 is arranged above an insert component 16 that is or can be connected removably (in a damage-free and non-destructive manner) with the housing 8, arranged downstream of the filter device 10. The insert component 16 subdivides the housing interior 9 into an upper housing interior area 9a located above the insert component 16 and a lower housing interior area 9b located below the insert component 16. The insert component 16 provides a, here central, flow opening (not denoted in more detail) that can be run through by the gas flow 7. The drying element 15 is arranged in the upper housing interior area 9a and fills it at least partially, possibly completely.

The gas flow 7 runs purposefully with a comparably low flow rate, i.e., especially a flow rate of less than 3 m/s, especially less than 1 m/s. Such low flow rates improve, due to a longer residence or interaction time, both the separation result achievable with the filter device 10 and the drying result achievable with the drying device 14.

FIG. 2 shows a schematic diagram of an arrangement 17 according to an exemplary embodiment.

The arrangement 17 is provided for the inertization or preinertization of a housing interior 9 defined by a housing structure 8 of a separating apparatus 1 to be rendered inert, for separating particulate construction material components from an inert gas flow 7 containing particulate construction material components arising related to the process in a process chamber of an apparatus 3 for additive manufacturing of three-dimensional objects 4 by successive selective exposure and thus solidification of individual construction material layers of a construction material that can be solidified by means of an energy beam 6. The inert gas flow 7 can be, for example, an argon or nitrogen gas flow.

The arrangement 17 comprises several first separating apparatuses 1a, each providing a housing interior 9 defined by a housing structure 8 that is to be rendered inert, and a second separating apparatus 1b connected downstream of the first separating apparatuses 1a, comprising a drying device 14 which comprises a drying element 15 for drying the gas flow 7. The further separating apparatus 1b can, as indicated by the dashed line, optionally comprise a filter device 10. The first separating apparatuses 1a and the second separating apparatus 1b are connected with each other by means of a pipe structure 13 that is or can be run through by an inert, i.e., serving for inertization, gas flow 7. The second separating apparatus 1b is especially a separating apparatus 1 according to the exemplary embodiment shown in FIG. 1.

The downstream connection of a respective second separating apparatus 1b according to the arrangement allows a preparatory inertization (“preinertization”) of respective first separating apparatuses 1a prior to initial operation within the scope of an additive construction process. The preinertization can be performed at least partially, i.e., the housing interior still contains a certain fraction of non-inert gas, i.e., for example, oxygen, or completely, i.e., the housing interior contains no fraction of non-inert gas. In all cases, a (considerable) reduction of the setup times for a first separating apparatus 1a to be used within the scope of an additive construction process is possible. Of course, apart from the inertization, drying is performed as well, i.e., a reduction of any moisture content possibly contained in the respective first separating apparatuses 1a.

The pipe structure 13 forms a closed flow circuit into which the first separating apparatuses 1a and the second separating apparatus 1b are connected. The inert gas flow 7 therefore runs circuit-like through the separating apparatuses 1a, 1b, which allows a particularly efficient inertization of the first separating apparatuses 1a.

The first separating apparatuses 1a to be rendered inert are connected in series and form a group 1A of separating apparatuses 1a to be rendered inert. The second separating apparatus 1b is connected downstream of the group 1A (as regards the gas flow). Hence, the inert gas flow 7 runs through the group 1A first and then through the second separating apparatus 1b. A flow generation device 18 providing for the generation of a respectively running gas flow 7, i.e., for example, a blower device, is connected upstream (as regards the gas flow) of the group 1A. From the described arrangement it follows that the first separating apparatus 1a of the group 1A arranged closest to the second separating apparatus 1b is the one that is rendered (pre)inert most rapidly.

The arrangement 17 furthermore comprises a detection device 19 coupled with the pipe structure 13 for detecting information on the degree of moisture describing the moisture content or degree of moisture of the inert gas flow 7 running through the pipe structure 17 and a detection device 20 for detecting information on the degree of inertization describing the degree of inertization of the gas flow 7 running through the pipe structure 13. The information on the degree of moisture, for example, can be determined or described by detecting the fraction of water molecules in the inert gas flow 7. The information on the degree of moisture gives an indication of the efficiency of the drying device 14 or drying element 15, which can therefore be replaced (early) if required. The information on the degree of inertization can, for example, be detected or described by detecting the fraction of reactive gases, especially oxygen, or the fraction of inert gases, especially argon or nitrogen, in the inert gas flow 7. The respective detection device 19, 20 is equipped with suitable detection elements (not shown), i.e., especially sensor elements, for detecting the fraction of moisture, especially the fraction of water molecules, or the fraction of reactive gases in the inert gas flow 7.

The arrangement 17 furthermore comprises a control device 21 implemented by hardware and/or software for controlling the fraction of inert gases in the inert gas flow 7 and an inert gas supply device 23 connected with an inert gas reservoir 22 or inert gas source for supplying (additional) inert gas into the pipe structure 13. The control device 21 is provided for controlling the operation of the inert gas supply device 23, especially dependent on information on the degree of inertization. The supply of (additional) inert gas into the pipe structure 13 is typically performed when the fraction of reactive gases exceeds a certain limit value. For oxygen it applies, for example, that the limit value is exceeded when the fraction of oxygen exceeds two vol. %. The pressure increase involved with the supply of (additional) inert gas into the pipe structure 13 is compensated via a possibly opening valve device 24, for example, in the form of a pressure relief valve. The valve device 24 is exemplarily arranged in the area of the flow generation device 18. With pressure compensation realized in such a way, gas, which, of course, also contains reactive gas components, escapes from the pipe structure 13, resulting in a successive reduction of the fraction of reactive gases in the gas flow 7.

FIG. 3 shows a schematic diagram of an apparatus 3 according to an exemplary embodiment. As mentioned above, the apparatus 3 in FIG. 3 is shown in connection with a separating apparatus 1.

The apparatus 3 serves for additive manufacturing of three-dimensional objects 4, i.e., for example, technical components or technical component groups, by successive selective exposure and thus solidification of individual construction material layers of a construction material 5 that can be solidified by means of an energy beam 6. The energy beam 6 is a laser beam. The apparatus 3 is an SLM apparatus, i.e., an apparatus for performing selective laser melting methods (SLM methods). The selective solidification of respective construction material layers to be solidified is performed based on object-related construction data. Respective construction data generally describe the geometric or geometric structural design of the respective three-dimensional object 4 to be additively manufactured. Respective construction data can be, for example, “sliced” CAD data of the object 4 to be manufactured.

The apparatus 3 comprises the functional components required for performing additive construction processes, i.e., especially an energy beam generation device 25 for the generation of an energy beam 6 for successive, selective layer-by-layer solidification of individual construction material layers of the construction material 5, i.e., especially a particulate or powdered metal such as aluminum, stainless steel, or titanium, and an, as indicated by the horizontally oriented double arrow, movably supported coating device 26 for forming construction material layers to be solidified in a construction plane.

The apparatus 3 furthermore comprises at least one separating apparatus 1. The separating apparatus 1 allows in situ both separation of respective particulate construction material components from a respective gas flow 7 running out of the process chamber 2 of the apparatus 3 and drying of the gas flow 7. Drying reduces or prevents moisture enrichment, which has negative effects on the respective additive construction process and the three-dimensional objects 4 that are or can be manufactured additively with it.

In the exemplary embodiment according to FIG. 3, the drying device 14 associated with the separating apparatus 1 is arranged on or in a an, especially tubular, pipe element 13 coupled downstream with the housing 8 as regards the gas flow. The drying element 15 is arranged in a pipe element section that can be run through by the gas flow 7.

In the exemplary embodiments shown in the Fig., the drying element 15 is exemplarily an adsorptive drying element 15. The adsorptive drying element 15 allows the adsorption of moisture contained in the gas flow 7. Concretely, the adsorptive drying element 15 can be a molecular sieve, which allows an adsorptive connection or bonding of water molecules. As actual drying material, the drying element 15 can comprise, for example, aluminosilicate (zeolite). As mentioned, the drying material can be (loose) powder. The pore size of a respective drying material is chosen purposefully with regard to the size of water molecules and can lie, for example, in a range between 0.3 and 1 nm.

1. A separating apparatus (1) provided for separating particulate construction material components from a gas flow (7) containing particulate construction material components arising related to the process in a process chamber (2) of an apparatus (3) for additive manufacturing of three-dimensional objects (4) by successive selective exposure and thus solidification of individual construction material layers of a construction material (5) that can be solidified by means of an energy beam (6), characterized by:
a housing structure (8) defining a housing interior (9) that is or can at least sectionally be run through by a respective gas flow (7),
at least one filter device (10) arranged or formed in the housing interior (9) which comprises at least one filter element (11) for separating the particulate construction material components from a respective gas flow (7),
at least one drying device (14) which comprises at least one drying element (15) for drying the gas flow (7).

2. A separating apparatus according to claim 1, characterized in that the drying device (14) is arranged or formed inside the housing interior (9) defined by the housing structure (8).

3. A separating apparatus according to claim 2, characterized in that the drying device (14) is arranged or formed on an insert component (16) removably connected with the housing structure (8), especially arranged or formed downstream of the filter device (10), wherein the insert component (16) has at least one flow opening that can be run through by the gas flow (7), and the drying element (15) is arranged or formed in the area of the flow opening.

4. A separating apparatus according to claim 1, characterized in that the or another drying device (14) is arranged or formed outside the housing interior (9) defined by the housing structure (8).

5. A separating apparatus according to claim 4, characterized in that the drying device (14) is arranged or formed on or in an, especially tubular, pipe element (13) that is or can be coupled with the housing structure (8) upstream or downstream as regards the gas flow, wherein the drying element (15) is arranged or formed on or in an, especially tubular, pipe element section that can be run through by the gas flow (7).

6. A separating apparatus according to claim 1, characterized in that the drying element (15) is formed as or at least comprises an adsorptive drying element, especially a molecular sieve, provided for adsorbing moisture.

7. An apparatus (3) for additive manufacturing of three-dimensional objects (4) by successive selective exposure and thus solidification of individual construction material layers of a construction material (5) that can be solidified by means of an energy beam (6), comprising at least one separating apparatus (1) according to claim 1.

8. An arrangement (17) for an at least partial inertization of a housing interior (9) defined by a housing structure (8) of a separating apparatus (1b) to be rendered inert, provided for separating particulate construction material components from a gas flow containing particulate construction material components arising related to the process in a process chamber (2) of an apparatus (3) for additive manufacturing of three-dimensional objects (4) by successive selective exposure and thus solidification of individual construction material layers of a construction material (5) that can be solidified by means of an energy beam (6), comprising:
at least one first separating apparatus (1a) providing a housing interior (9) defined by a housing structure (8) that is to be rendered inert,
at least one second separating apparatus (1b) connected downstream of the at least one first separating apparatus (1a) comprising at least one drying device (14) which comprises at least one drying element (15) for drying a gas flow (7), especially a separating apparatus (1) according to claim 1,
wherein the at least one first separating apparatus (1a) and the at least one second separating apparatus (1b) are connected with each other by means of a pipe structure (13) that is or can be run through by an inert gas flow (7).

9. An arrangement according to claim 8, characterized by several first separating apparatuses (1a) to be rendered inert, wherein the first separating apparatuses (1a) to be rendered inert are connected in series and form a group (1A) of separating apparatuses (1a) to be rendered inert, wherein the at least one second separating apparatus (1b) is connected downstream of the group (1A) as regards the gas flow.

10. An arrangement according to claim 8, characterized in that the pipe structure (13) forms a closed flow circuit, wherein the at least one first separating apparatus (1a) and the at least one second separating apparatus (1b) are connected into the closed flow circuit.

11. An arrangement according to one of the claim 8, characterized by a detection device (19) which is or can be coupled with the pipe structure (13) for detecting information on the degree of moisture describing the degree of moisture of the inert gas flow (7) running through the pipe structure (13) and/or a detection device (20) for detecting information on the degree of inertization describing the degree of inertization of the inert gas flow (7) running through the pipe structure (13).

12. An arrangement according to claim 8, characterized by a control device (21) for controlling the fraction of inert gases in the inert gas flow (7) and an inert gas supply device (23) for supplying inert gas into the pipe structure (13), wherein the control device (21) is provided for controlling the operation of the inert gas supply device (23), especially dependent on information on the degree of inertization.
